(19) United States
(12) Patent Application Publication
(10) Pub. No.: US 2020/0326660 A1
(43) Pub. Date: Oct. 15, 2020

(54) METHOD AND APPARATUS FOR UNIVERSAL TIME SIMULATION AND CO-ORDINATION FOR GENERATING FREQUENT ORIGIN MILESTONE

(71) Applicant: Harish Sivaramakrishnan, Chennai (IN)

(72) Inventor: Harish Sivaramakrishnan, Chennai (IN)

(21) Appl. No.: 16/382,236

(22) Filed: Apr. 12, 2019

(51) Int. Cl. G04C 11/00; G01C 21/02; G04G 9/00; G06F 17/50

(52) U.S. Cl. CPC G04C 11/00; G06F 17/5009; G04G 9/0076; G01C 21/025

(57) ABSTRACT

The invention with its state-of-the-art and innovative methods has established a time simulation phenomenon pertaining to celestial objects independently for (14) Universal Time (FIG. 1). The co-ordination between three celestial objects Earth, Moon, and Sun are the significant sources for back mapping and the method remains immaculate and perfect in ascertaining the Universal Time Co-Ordination (15). The invention has delivered the classified integrity while implementing the most impressive and innovative methods in bringing-out a novel concept (9) and (10) for Universal Time Simulation. The Universal Time (14) and Universal Time Co-ordination phenomenon provide a leap ahead in worldwide clocks and time regulation in which clocks would be (7) self-synchronizing based on specific locations. The location-specific Time would be incorporated to have a reality-based transition in the framework of Universal Time and Universal Time Co-Ordination that would benefit watch manufacturing industry massively (7). The invented method also provides a framework for high-level precision clocks in research labs to check their integrity in timescale (16). The pioneered method in this present invention would benefit space industry to the maximum possible extent (FIG. 4) with its limited kernel (3) memory usage statistics. The singularity in the definition of Universal Time (14) would enhance simultaneous space mission programs.

Universal Time and Universal Time Co-Ordination are key aspects in the following areas namely:
Regulation of Clock and Time, World Wide Web, Network Time Protocol, International Broadcast, Weather Forecast, Air Traffic Control, Radio Stations, Space Technology.

### BACKGROUND OF THE INVENTION

### Field of the Invention

The presently invented method is directed in handling Universal Time and dual-angular Co-ordination in Universal Time to form Universal Time Co-ordination as a phenomenon with functional accuracy on the computer with a hardware processor architecture of 32-bit configuration with minimized memory usage statistics known for its non-obvious nature of execution by providing frequent milestone origin points in simulation framework for nine hundred and ninety-nine million years.

### Description of the Related Art

The Co-ordinated Universal Time is a combination of both macrophysics and microphysics. The macro-level physics encapsulates the working principle of celestial mechanics and the micro-level physics implements the real-time active timekeeping clocks. The high-level precision powered clocks help in uncovering of aberrations in time-associated macrophysics with an understanding of their orbital exercise. The prior art of matchmaking between the timescale and celestial objects is highly questionable due to balancing rigidity in the phenomenon. Microphysics encompasses itself as extreme fractional-state and other associated behaviours. Balancing the SI units attributes with macrophysics becomes enormously tedious and delivers deficits in deriving an accurate Co-ordinated Universal Time in the prior art. Hence, incessant monitoring of timescale at extreme alerts is sought for maintaining the classified integrity in Timescale and SI units.

The Co-ordinated Universal Time (UTC) remains followed only by converging with Earth's revolution and its leap seconds, the successor of GMT. The revolution of Earth and timescale is significantly kept to ensure leap second strategy applied when the accumulation exceeds the correction point. This is termed as an ad-hoc correction. The revolution of the earth is strictly monitored by the earth observatory labs in the world and the ad-hoc corrections are applied according to the articulated circular among time laboratories in the world for maintaining the Co-ordinated Universal Time.

The SI units define the fundamental weight of mean interval in a sequential progression in high-level precision-based clocks by employing microphysics. Timescale in clocks is a core and integral part for maintaining accuracy within SI units using applied microphysics. These high-level precision clocks maintain Co-ordinated Universal Time with predefined SI units that are static in nature. The High-level precision clock mechanism is pioneered with extreme fractional accuracy and static principle for functional execution, active timekeeping, and dependability for long-term duration using the core subject area of applied physics.

The astronomical obligation is regularly sought to balance the principle nature of revolution and to equate such instances to derive Universal Time. The prior art utilizes compound mathematical logic, which undergoes extreme stress to bridge the accuracy crack. The Derivation principle of Universal Time has logarithmic chart according to the prevailing century and prefixed macrophysics behaviour. The foundation of mathematical principle in the prior art of Universal Time is the legacy approach and does not support accurate mission-critical execution and perfection in today's computing and extended functionality.

The Sidereal standard refers to the celestial objects, which are placed in the deep sky for understanding macrophysics. The sidereal concept can benefit from determining an object in the sky to return to the same position approximately. The observation from the earth differs from time to time because of its revolution about its axis as well as around Sun. It is extremely hard to determine the behaviour of celestial objects since the place from where it is observed itself is displacing from moment to moment and hence astrophysicists and astronomers find it very challenging to prove the native behaviour of macrophysics' consistency in terms of accuracy in time. The position and angle of the planets differ from time to time and hence it is very problematic to prove the native behaviour due to the puzzling and unascertainable displacement, angle, position etc.

Earth revolves about its axis 360° in 23.93 hours according to the Sidereal timing that is 86164.0906 mean solar seconds. It moves in an elliptical orbit-path 360° about the Sun and completes one full Sidereal year of 365.256 mean solar days. A tropical year has a period 364.242 mean solar days, which is utilized for predicting tropical changes during its annual cycle about the Sun.

The below-explained perspectives are furnished to provide common understanding in the prior arts and the geometrical behaviour of Earth about the Sun in twelve months span as in a civil calendar of 365 days. This could be further divided into 4 quarters, each having 3 months duration for geometrical mapping determination. The overall average duration is 30.416666 recurring mean solar days, when distributed consistently for 12 months, it constitutes 365 days, which is being followed in the civil calendar. Earth requires an additional of 0.256 mean solar days for sidereal year completion and 0.242 mean solar days for tropical year completion. Therefore, the sidereal or tropical imbalance (i.e. 0.256 or 0.242) accumulates as 1 day in every 4 years. Hence, the usage of leap day i.e. 29 days in February in every 4 years is required to match make with Earth's revolution.

Moon revolves 360° about the Earth in 27.32 mean solar days but the moon takes an additional of 2.21 days to complete the synodic month or also known as one lunar month to be aligned with earth's position that can be split into four uniform quarters namely New Moon, First Quarter, Full Moon, and Last Quarter. One quarter measures 7.382 mean solar days taken by Moon to cover ¼ of the earth's disc. A lunar year is 354.372 mean solar days during when the Moon completes 12 lunar or synodic months around the Earth.

### BRIEF SUMMARY OF THE INVENTION

Up until now, the Co-ordinated Universal Time has been handled only in a single dimensional objective by focusing on timescale built on SI units to monitor Earth's revolution and associated changes. Whereas, the invented method simulates the Sidereal timescale of Earth, Sun, and Moon individually to Co-Ordinate in a lucid notation oriented geometrical track for modelling frequent conjunction timescale milestones. The Coordination-generated structures are completely based on a Sidereal timescale that are integrals and accurate methodology by involving celestial mechanics to standardize time phenomenon and derive the Universal Time and Universal Time Co-Ordination. The marvel of Sidereal and Tropical principle combined with angular progression enables to chart variation in angular geometry. The angular geometry emphasizes a singularity method adaptation to define the relationship in the Universe using the mapping of fixed or static objects.

The invented method utilizes Sidereal and Tropical timescales as a key instrument for regulating Universal Time and Universal Time Co-ordination unlike in prior arts, which uses predefined SI units. The Sidereal Timescale capitalizes the angular progression in combination with refreshing angular geometry for setting standards in the invented method. The invented method encapsulates macrophysics in combination with a Sidereal timescale for generating accurate Universal Time conjunction and origin points for various time simulation objectives on a computer processor architecture. The invented method uses the geometrical framework in connection with macrophysics for encapsulation in the digital environment, and structural formation of Universal Time and Universal Time Co-Ordination on a processor architecture known for its minimal memory usage statistics.

The sidereal timescale does not have much variation in its precision as it relates to static objects in the deep universe to regulate a geometrical framework. The invented method employs necessary precision laws and accuracy under full control to derive the geometrical co-ordination to form Universal Time and Universal Time Co-ordination. The digitalized methodologies become universally applicable to most celestial objects in the universe and especially Sun, Moon and Earth are particularly involved in this invented method to coordinate according to the invented Universal Time Co-ordination. The invented Method has identified techniques for handling complex, highly clashing, and puzzling objectives in connection with macrophysics while digitalizing Universal Time and Universal Time Co-Ordination in regulating a framework. Using the sidereal equinox method, the invention has formulated a framework solution for the Universal time and Universal Time Co-ordination as a singularity approach for redefining accuracy in digitalization.

The precision point utilizing Sidereal and Tropical timescale in the invented method overrides the dynamic nature prevailing in macrophysics by utilizing refreshing angular geometrical method in its framework, which has been compressed to handle the simulation of Universal Time and Universal Time Co-ordination on the Computer with X86 (32-bit) platform architecture by exploiting available digital boundaries. The acquired precision follows the geometrical mapping approach in deriving the Sidereal timescale and exemplifies in the simulation of Universal Time and Universal Time Co-ordination, matchmaking with each other.

The methodology associated with the invention attempts to define an originality approach for the prevailing conflicts in handling timescale, pertaining to macrophysics behaviours and redefine a single method to encapsulate the timescale phenomenon for practical usability. The invented method and its operational outcome (Universal Time and Universal Time Co-ordination) for various celestial objects in the digital environment like computers is a prototype for encapsulating macrophysics prevailing in the universe pertaining to generate time structure phenomenon.

The invented method uses a dual-angular progression in the simulation with its individual time simulation origin to coordinate by its automated conjunction geometrical nature for regulating frequent origins in timescale. The dual-angular progression mechanism is contemporary to add a new dimension to the Universal Time Framework. As a contrast, Eclipses are not consistent conjunction origins for time simulation. Eclipses have deprived support to standardize timescale for usability and occur in a differentiated timeframe that is rigid and composite to maintain timescale. Hence, eclipses cannot standardize the timescale and the principles are not compatible for problem-solving associated with Universal Time framework. The invented method uses a dual-angular progression simulation to standardize timescale with accuracy by facilitating multiple origin points for practical usability, which satisfies the objectives in Universal Time Framework.

The prior art of Co-ordinated Universal Time attempts to manage its built-in timescale to support the revolution of Earth. Whereas, the concept of dual-time co-ordination introduces multiple accountabilities of celestial objects Sun, Moon, and Earth to standardize timescale by making the three objects to Co-Ordinate in the geometrical layout in a lucid manner and finds a legendary leap in the framework of Universal Time. The invented method in digital environment generates timescale structures, addresses problems without manipulating and reflects the behaviour of macrophysics in the universe.

The Revolving progression method attempts to define the scope of revolution in connection with celestial objects. Whereas, the angular progression defines the extreme fractional state in its progression while accommodating the whole number as well by facilitating geometrical mapping. The invented method of Universal Time and Universal Time Co-ordination closely monitors the angular positioning of Earth associated with Sun and Moon, using its Sidereal and Tropical equinox for its mutual time simulation, which is complex in its definition.

The invented method uses angular progression for the Sidereal and Tropical year to categorize a division among Universal Time framework and to define various changes in the contract with geometrical displacement. The equator splits the earth into two halves. The earth in slanting position attributes to the causing of different types of climates, one above the equator, and one below the equator while making the annual journey about the Sun. The invented method uses two types of angular progressions with its displacement and the revolving of the Earth around the Sun and ascertains the Universal Time simulation from the immediate midnight of conjunction. The Universal Time and Universal Time Co-ordination Framework go beyond geometrical mapping to uphold accuracy and dependability. The Universal Time in the invented method provides a prototype for high-level precision clocks to check back the integrity of mean interval accuracy.

The digital standard of a processor architecture has limitation while computing floating point or fractions. The invented method for generating Universal Time and Universal Time co-ordination structures accommodates precision so-called floating-point to a high-degree of calculation. The floating-point remains accommodated up to nine hundred and ninety-nine million years without overloading processor architecture of 32-bit configuration making a big-leap by overriding hardware architecture, technical advancement, and problem-solving.

The rotation of celestial objects could be divided into four equal parts, each constituting 90° Angular displacement. The invented method utilized angular geometry as its basic framework instrument for devising its timescale in the digital environment. The consecutive angular displacement in four positions wherein it absolutely covers 90° from the previous point and the position is identifiable and defines such precise geometrical displacement in computing without any lapse.

The prior art of Co-ordinated Universal Time and Date retains to vary as time passes due to unstable co-ordination between macrophysics and microphysics implementation in high-level precision clocks. The presently invented method uses Date construction principle using geometrical mapping to facilitate back mapping, which is the most accurate means to understand celestial alignment between Earth, Moon, and Sun that remains flawless in the framework of Universal Time. Date objects need to be derived only by focusing on the exact angular position of celestial geometry. The invented method overrides the dynamic nature by exploiting geometrical mapping in regulating the Universal Time co-ordination by taking into consideration the position of three celestial objects for time simulation. The combination of three Celestial objects retains top-classified integrity in the framework of Universal Time, Universal Time Co-Ordination, and Date Structure generation, with flawless mutual alignment among them.

Utilizing Sidereal and Tropical equinox method, Sun as the centric celestial object, Earth revolving about its axis and Sun, and Moon revolving about Earth, formulizes celestial mechanics standardization. The Sun's light falling on the Earth as well as on the Moon attempts to define the illumination manifestation in broad view of the geometrical displacement. The Moon's displacement to the extent of 90° wherein, Earth is placed in an unbiased position in order to fetch a rich understanding of the behaviour in geometry encompasses macrophysics. In the next immediate session, the Moon makes an additional 90° movement from the previous position to generate its individual nature of behaviour in celestial mechanics around the earth and consequently building four sessions of 90° in geometrical Framework. The angular displacement attempts to define and acquires the sidereal equinox of Earth and Moon to have a mutual time simulation according to the invented method in Universal Time Framework.

The invented method has recognized its unique phenomenon in the derivation of Universal Time and Universal Time Co-Ordination on a computer platform for its simulation. The invented method attempts to override the dynamic nature of the Celestial objects while considering their exciting functioning nature by exploiting static geometrical framework. The invented method will exemplify its implementation remarkably in the Space industry, especially when space shuttle is at frequent intervals. The profound method has minimized the kernel memory usage statistics for such complicated spacecraft missions. The invented method would serve as a base-line time phenomenon for space-traffic to organize multiple landing programs at different destinations since the invented method has a singularity approach in the angular framework. Furthermore, the customization of application with adequate changes would facilitate other celestial objects to be charted with similar accuracy for various other space missions and shuttle.

The invented method utilizes conjunction origins for simulation of Universal Time Co-Ordination and independent Universal Time simulation with its pioneered geometrical synopsis and accommodating extreme level floating-points for an enormous range of functionality in Universal Time structure generation. The introduction of a new set of methodologies is defined for this generation to understand better than ever before and has established its phenomenal capacity.

The diagrammatic illustration in FIG. 3, the displacement of Earth with respect to tropical equinox method moves ninety-degrees around the Sun in a span of three months approximately to complete a twenty-five percent of its annual journey. However, the Earth moves in an elliptical-path from the origin and its angled equator, with geometrically drawn perpendiculars, a right-angle triangle is constructed. The exact revolution of Earth may not stick on to the circular-path due to the gravitational fluidity in macrophysics, but still, it has to pass through the vertices of the right-angle triangle, wherein ninety-degree displacement could be acquired using the geometrical framework in combination with the tropical equinox. The continuation of the pattern in the geometrical framework ranging from 90° to 180° in which 180° becomes the origin for the next session. The repetition of displacement contributes to consecutive geometrical mapping. In the concluding stage, Earth makes a movement of 90° from 270°-360° wherein it crosses the original position according to the opted equinox method of alignment.

The diagrammatic illustration in FIG. 4, exhibits how the Moon is pivoted with the Earth and bound to customize itself with the Earth's behaviour since Earth's quantum of gravity is higher and hence Moon is required to accompany the annual journey with Earth around the Sun in a spiral pattern. The Moon has its own distinct behaviour.

The illumination of the Moon contributes to identify four phases of the Moon. There exists a centrifugal force between Moon and Earth, which maintains the co-rotating frame and bridges the Moon along with the Earth's elliptical orbit without being isolated away. Such geometrical flow of mapping is charted with high-level precision to define their co-rotating behaviour. The path of the Moon in a spiral pattern without discarding the true nature benefits to define the geometrical framework and associated equinox in macrophysics.

The spiral pattern in geometry delivers to build and define a mutual simulation point in angular progression.

### BRIEF DESCRIPTION OF THE SEVERAL VIEWS OF THE DRAWINGS

FIG. 1: Universal Time & Universal Time Co-Ordination on 32-bit Processor

The Drawing efforts to define the complexity of the newly invented method, which provides a spectrum for the assembly of Universal Time & Universal Time Co-Ordination using its explicit operational methods and mechanisms on a computer Architecture with configuration 32-bit processor Architecture. The drawing provides a practical expression of non-obvious nature in the behind making of such crafted technological advancement considering its operational merits in the digital environment and technical problem-solving nature. There exists a functional discomfort in most processor architecture while handling extreme Floating points; the invented method operates with such high-level precision for nine hundred and ninety-nine million years for generating frequent origin milestone in Universal Time and Universal Time Co-Ordination.

FIG. 2: Flowchart for Universal Time & Universal Time Co-Ordination

The Flowchart outlines the systematic functional execution involved in the entire method for building the Universal Time and Universal Time Co-ordination optimized in a top-down flow. The top-down flow indicates step-by-step actions from input to output in a result driven approach that are key constituents that build the complete multiple methods involved to achieve the functional outcome of the invention. The geometrical framework that acts as a backbone to the angular progression is the top-level initiation. The Flowchart indicates the mono-track angular progression and dual-angular progression method for the simulation of Universal Time and Universal Time Co-ordination. The angular progression method by the Floating point framework is also clearly a part of the constituents. Finally, the output system is responsible for displaying user-end information on the customized user interface window.

FIG. 3: Macrophysics encompasses Geometrical Framework Using Extreme Fractional State

The Drawing elucidates and illustrates the macrophysics settings that includes geometrical framework as key composition for mapping and makes definitive methods for handling extreme fractional-state in angular progression by defining the key ideology of Universal Time Simulation. The dual-angular progression with its simulation in digital environment generates automated conjunction for Universal Time Co-Ordination. The dual-angular progression has a combination of two celestial objects to form mutual alignment. Geometrical mapping as a back-bone supports angular progression to simulate accurate time phenomenon pertaining to Universal Time Standards. The geometrical and angular Metrics regulate to define Universal Time individually while simulating a single instance and furthermore, in mutual combination effort, to the classification of conjunction with extreme Epsilon usage statistics encompassing macrophysics. The Geometrical Framework facilitates conjunctions in the angular progression by its automated simulation in defining a timescale standardization.

FIG. 4: Spiral & Refreshing Angular Geometrical method with Displacement.

The Diagram depicts the most essential path-breaking spiral geometry in its native behaviour. The spiral geometry mapping attempts to define the scope of an object with its extreme differentiated displacement from time to time. The geometrical spiral displacement is determined with a refreshing angular geometrical method that assists to rebuild the relationship in the angular framework. In differentiated angular progression, refreshing angular geometry accounts to the new consecutive sessions with mapping essentials, to generate the angular displacement with accuracy for building Universal Time framework.

### DETAILED DESCRIPTION OF THE INVENTION

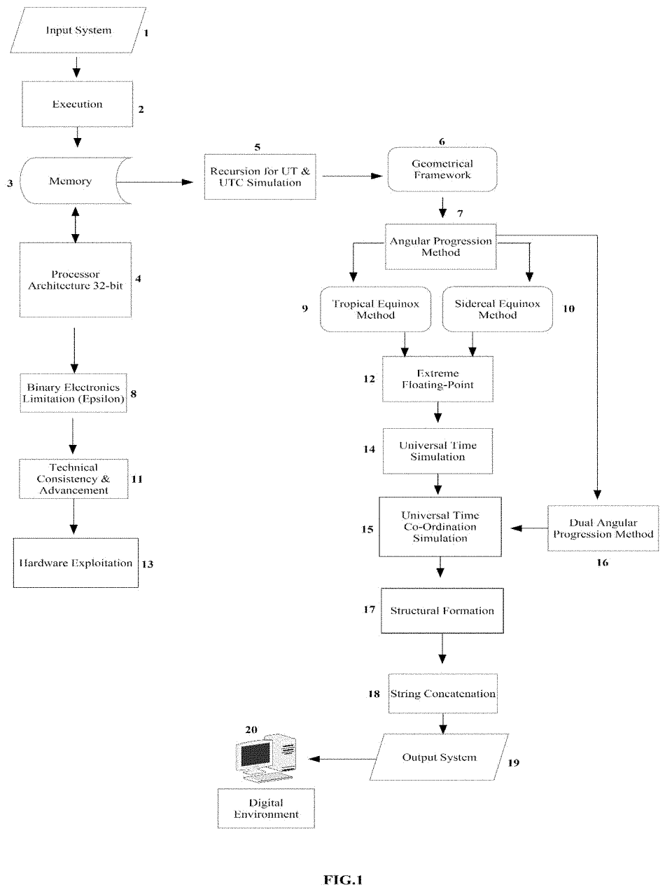

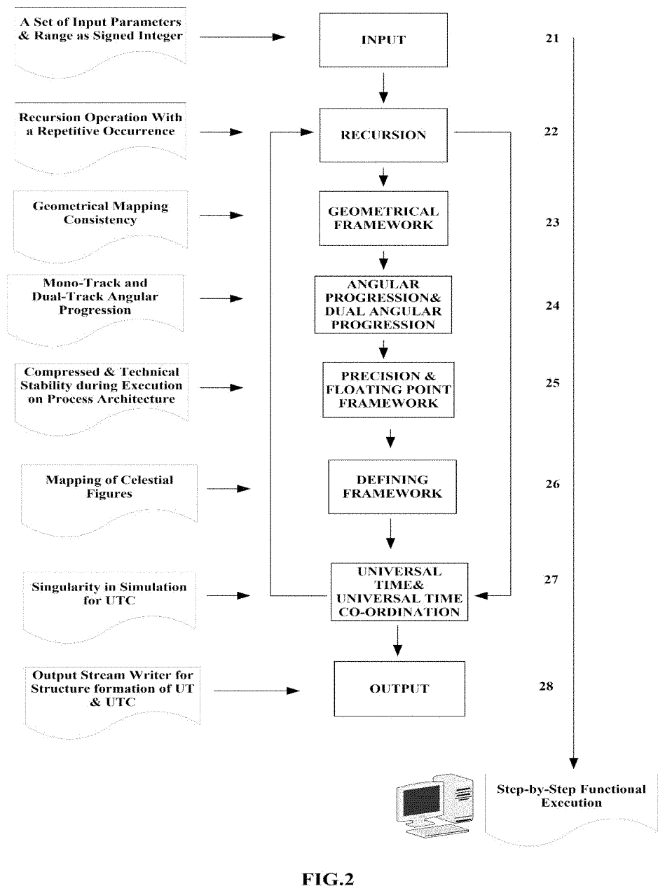

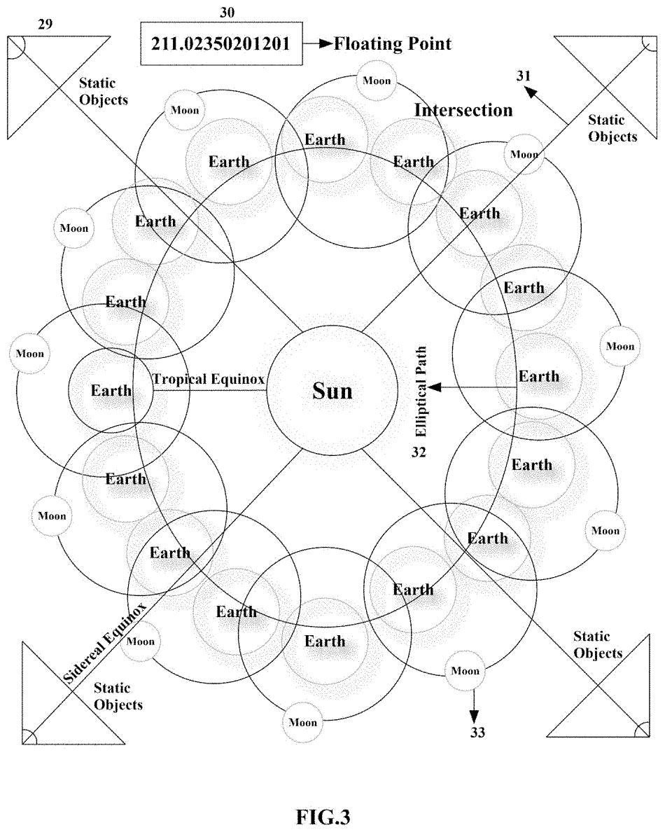

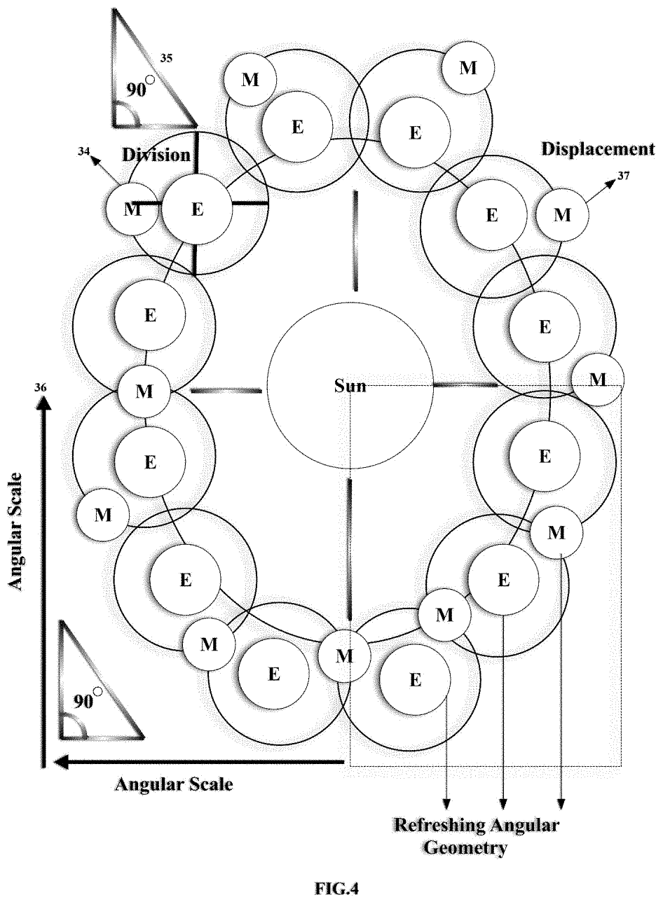

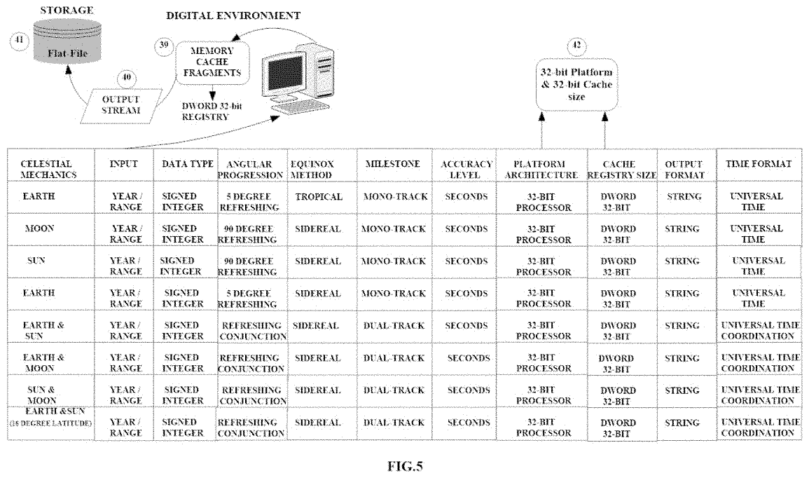

FIG. 1: Universal Time & Universal Time Co-Ordination on 32-bit Processor.

(1) Input System: The invented method utilizes the input system of the computer using Keyboard & mouse to interact with the designed application. The set of input parameters controls the behaviour of the application and end-result. The input parameters are gathered from the end-user using an application interface design and provide commands for execution.

(2) Execution: The designed application provides operational commands to process in a graphical user interface (GUI) environment. Once, the application is loaded into memory and executed, the set of parameters reach the processor for carrying out its operation based on the defined protocol and its explicit methods.

(3) Memory: The memory becomes a temporary storage area for the designed application and execution process. During the execution process of the application, there is an interaction between processor and memory for stack storage in the available memory. The memory address provides and identifies the location of the stored data after execution. The designed application retrieves the required data from the memory using the stack address. The invented method under extreme fractional-state execution uses only limited memory resources that is a hallmark in technology advancement.

(4) Processor Architecture 32-bit: The digital standard of processor architecture is defined by its binary operation capabilities. The binary electronics plays a vital role in processor architecture. Mathematically speaking, 32-bit processor architecture standards are defined as 2³², the base two stands for the notation of 0's and 1's and the processor architecture binary computing limitation is the power of base two. The ‘0’ and ‘1’ are the basis for digital electronics comprising binary mathematics. The processed data is stored in the memory for future usage by the designed applications.

(5) Recursion for UT & UTC Simulation: The invented method utilizes recursion in the instruction set of programmed application. Recursion is utilized to carry out repetitive instruction for lengthy uninterrupted execution chain. The invented method ensures that recursion procedure involves a termination point after completing the entire execution. The recursion helps to take advantage of the processor architecture load and the execution to occur in an efficient way. Operation of Recursion uses high-level inbound logics.

(6) Geometrical Framework: A Geometrical framework in the invented method attempts to define the scope of intersection in the geometrical plane in connection with macrophysics. The framework acts as a backbone and provides its preferred equinox method to define the intersection of geometrical planes for mapping. The compound computation involved in the invented method fetches absolute co-ordination by structuring its own phenomenon. The geometrical framework in the invented method provides a reference point for timescale simulation enduring the intersection of the plane.

(7) Angular Progression method: An angular progression is defined in a geometrical manifestation with its fractional progression state in the invented method. The invented method capitalizes angular progression in amalgamation with recursion to generate angular structures. The Angular structure milestone provides a framework for timescale simulation in the invented method.

(8) Binary Electronics Limitation: The binary limitation is characterized by the processor architecture. The Architecture provides a boundary for binary electronics to function. The binary electronics is the bottom layer of execution in computation. The nature of binary computing and instruction involves only 0's and 1's. The programmed instruction-set is translated into binary instruction for processing and translated back into the appropriate format for human understanding. For processing the instruction-set, the limitation of the architecture plays a vital role in binary orientation. Hence, binary electronics limitations are crucial for tasks associated with computing.

(9) Tropical Equinox: The invented method standardizes the tropical equinox for building its specific timescale in connection with the intersection of the geometrical plane. The Tropical equinox remains beneficial in charting the angular variation in the rotation of Earth by formulating absolute coordination with its timescale. The Tropical Timescale generated by this invented method provides the framework for the simulation of Universal Time under Tropical Equinox method.

(10) Sidereal Equinox: The invented method standardizes sidereal equinox with its angular progression, contrasting with static objects for building specific timescale. The sidereal Equinox remains as a manifestation in geometrical mapping contrasting with other object's conjunction plane. The Sidereal Timescale generated by this method provides the framework for the simulation of Universal Time & Universal Time Co-ordination under Sidereal Equinox method.

(11) Technical Consistency & Advancement: The invented method has standardized its technological advancement and consistency in the formation and interpretation of instructions. The invented method ensures consistent result out-come with incredible advancement for its utility merits.

(12) Extreme Floating-Point: The described method attempts to define high-level precision in the program-instruction-set. Such heavily loaded operations require mass processor capability for the functionality of accuracy. The functioning of floating-point on the processor architecture is burdensome to compute and maintain top-level integrity and accuracy. The invented method facilitates the exploitation of compressed fractional execution to accommodate the enormous length of extreme floating-point along with a whole number or signed integer value.

(13) Hardware Exploitation: The high-level precision program with the instruction-set, accommodates the execution within the given hardware capacity with 32-bit processor. The experimental function provides the maximum possible capacity load of such high-level precision based operations on the given hardware. The successful end-point of computation of precision on hardware provides end-boundary limitations. There is a constant interaction between the processor and memory during the execution and computed data are stored in memory temporarily. Considering the memory storage volume, the involvement of high-level precision-based task requires enormous memory and processor usage. These usage statistics of processor and memory provide the practical evidence of technical advancement compared with normal standards of operations.

(14) Universal Time Simulation: The invented method categorizes the timescale into two type's namely Tropical equinox and Sidereal equinox timescale. The angular progression remains associated with either one of the methods to formulate the simulation of Universal Time independently. The Universal Time simulation remains enforced to all celestial objects individually by utilizing Sidereal equinox method.

(15) Universal Time Co-Ordination Simulation: The invented method aligns conjunction of two celestial objects within the framework of Universal Time to generate common co-ordination in the angular framework as a milestone to simulate its timescale phenomenon. The Universal Time Co-Ordination uses only sidereal equinox method as a tool to align mutual angular positions for its framework in timescale. The Universal Time Co-Ordination provides a singularity in its approach to define the complex polarization in co-ordination and timescale.

(16) Dual Angular progression method: the dual angular progression method involves invoking two simultaneous progressions to run at the same instance to generate mutual conjunction by exploiting automation in recursion procedure. It comprises the instances of two independent angular progression task to facilitate automated mapping under the extreme conditional state.

(17) Structure formation: The structural formation is the outcome of time simulation that has methods and procedures upon which the outcome is achieved. The structure formation in the invented method handles with numerals for the propagation of Universal Time and Universal Time Co-Ordination.

(18) String Concatenation: The concept of concatenation in this invention is utilized to make information more readable and useful. The concatenation helps to shape the processed outcome into well-organized data and informative to the end-user in the graphic user interface (GUI) environment.

(19) Output System: The invented method utilizes the output system to display its functional outcome and associated results to end-user.

(20) Digital Environment: The invented method operates in a digital environment like computer.

FIG. 2: Flowchart for Universal Time and Universal Time Co-Ordination.

(21) Input: All input parameters gathered from end-user are signed integers and have a combination of executional commands in the Graphic User Environment. The user input interface provides an option to control the progression process or length. Some parameters are initialized to the default values for the smooth functioning of the application

(22) Recursion: The recursion is the top-layer in the design and formulates composite programmed instruction-set within itself. The recursion optimizes the execution flow and sequence for performance purpose.

(23) Geometrical Framework: The geometrical framework provides essential techniques and methods to manage celestial objects precisely in developing their customized behaviour for charting in the digital environment and utilizing it for the timescale.

(24) Angular Progression: Angular progression is a succession of continuous segments constituting zero to three sixty degrees with high-level dependable precision norms in digital computing. The angular progression provides degree milestones for precise accountability.

(25) Dual Angular Progression: Dual-angular progression invokes two angular progressions simultaneously for automated mutual intersection by matching similarity in the conjunction state. The conjunction point provides a customized timescale for time simulation.

(26) Precision & Floating-point Framework: The invented method has customized operational functionality to accommodate high-level precision using compressed fractions for a long duration in its mandate framework for accuracy resistance.

(27) Defining Framework: The invented method utilizes angular progression of either Tropical equinox or Sidereal equinox for the mapping of celestial objects independently in geometrical framework. The Tropical equinox method is sought for proximity variation in contrast with Earth. The Sidereal Equinox is sought for Universal Time Co-Ordination.

(28) Universal Time & Universal Time Co-ordination: The Universal Time simulation is complemented by either Tropical equinox or Sidereal equinox method for handling timescale of a single entity by the invented method. The Universal Time Co-ordination utilizes only the Sidereal Equinox method and attempts to build a mutual conjunction point for its purpose oriented Sidereal timescale simulation. The invented method uses Sidereal Equinox phenomenon that devises a singularity in the approach for conscripting Universal Time Co-Ordination by using sidereal revolution

(29) Output: The invented method provides a range of highly valuable information as a prototype for various operations pertaining to Universal Time and Universal Time Co-Ordination.

FIG. 3: Macrophysics encompasses geometrical framework using Extreme Fractional State.

(29) Right-Angle: In the diagrammatic illustration pertaining to the geometrical framework, the right-angle triangle in all four corners attempts to define a sidereal reference point of intersection at 45 degrees from its perspective. The Right-Angle refers to most static objects in the deep sky. The invented method divides the angular progression sector by sector for mapping in geometry and stays witnessed as a back-bone. The invented method acquires the progression and its successive chain to define the framework.

(30) Floating-Point: Floating-point is the most sought in connection with compound macrophysics computations. Floating-point with the apt involvement of accuracy is the most foreseen challenge in digitalization. The invented method utilizes compressed Floating-point to accommodate lengthy fractional-state (Epsilon) with integers for stability and uncompromised accuracy.

(31) Intersection: The intersection line from the centre in the geometry provides the conjunction point of celestial objects. It provides a framework for coordination with most celestial objects. The intersection is determined by either the Sidereal Equinox method or Tropical Equinox method. The invented method kick-starts the time from mid-night after the coordination of the celestial objects in the defined geometrical framework for the simulation of Universal Time and Universal Time Co-ordination.

(32) Elliptical Path: The classified geometry provides the indication of an elliptical path of Earth during the annual journey around the Sun. The variation and associated classification in the Tropical equinox method provide the cyclic nature and proximity. The classified geometry accounts for most elliptical path pertaining to celestial objects.

(33) Moon: Moon makes its revolution around the Earth as well as the Sun in a spiral pattern as illustrated in the diagram. The spiral chain of Moon's path provides the mapping of Moon's Phases and Angle in the Universal Time framework.

FIG. 4: Spiral & Refreshing Angular Geometric Method

(34) Moon: The diagrammatic illustration describes the displacement of Moon in the annual cycle with differentiated positioning. The Moon's path is illustrated with its spiral nature of succession in angular progression method based on refreshing angular geometric method.

(35) Division: The path of Moon around Earth is divided into four sectors comprising Right angle for geometrical mapping. The mapping continues in a successive chain by refreshing angular geometry to chart the variation in angle in the invented method. The angular progression simulates the timescale for the individual celestial object using Sidereal Equinox.

(36) Angular Scale: The Angular scale delivers a measurement in terms of displacement involving angle. The angular scale is powered by the extreme fractional state by involving the equinox method to chart variation within a specified sector in the geometrical framework.

(37) Displacement: The Diagrammatic Illustration shows the displacement of the objects namely Moon and Earth during the annual journey around the Sun. The key indication in the illustrated diagram is the displacement of the Moon with its spiral nature.

(38) Refreshing Angular Geometric: The refreshing angular geometric method provides a high-level contrast with the new session in the geometrical framework for successive frame mapping. The refreshing angular geometry is utilized in various places pertaining to celestial objects in the invented method to support a high-level precision of geometrical mapping. The refreshing angular geometry remains powered by its frequent refreshing nature in the consecutive chain without any lapse in the angular progression.

### Physical Operational Features

According to (FIG. 1) the (1) provides end-user with a native keypad and mouse to interact with the user interface and the outcome is displayed to the interacting end-user with the help of a display unit like monitor (20) corresponding to the action performed by the end-user. The set of input parameters customizes and controls the behaviour of the simulation method according to the action performed. The user action is directed through the user-interface and thereon processing the instruction has a direct influence over the hardware especially the processor (4) for simulation and generating timescale structures. The input parameters are aggregated from the end-user using the user-interface and provide commands for execution which include a hardware architecture limitation or minimized hardware configuration. The commands are supported through a user interface (UI) environment. When the action is triggered by the end-user, the set of parameters reaches the processor for carrying out its operation based on the defined protocol and with its explicit timescale methods as numbered (9) and (10). The memory stack becomes a temporary storage area (3) for the designed method to store the execution outcome as fragments. During the execution process, there is a constant interaction between processor and memory for stack storage and exchange in the available memory by indicating two-way interaction (3) and (4) according to (FIG. 1). The stack storage space for generating Universal Time structures is the key technical advancement due to minimized memory usage statistics. The memory address provides and identifies the location of the stored data after execution. It retrieves the required data from the memory using a stack address for nine hundred and ninety-nine million years due to their extensive fragmented state.

The timescale functions under extreme fractional-state (12) in (FIG. 1) use only limited memory resources which is a hallmark in technology advancement considering its compressed execution in digitalization. The digital standard of processor architecture is defined by its binary operation capabilities. The binary electronics plays a vital role in processor architecture assessment. The said instruction-set has direct interaction with hardware in determining processor capacity to execute the progression length, else indicating an architecture overload to the end-user who performed the action. A 32-bit processor architecture standards are defined as 2³², the base 2 stands for the notation of 0's and 1's and the processor architecture binary electronics limitation is the power of base 2. The processor architecture has a binary electronic standard on which the device operates according to International Electrotechnical Commission (IEC). The present invented method for Universal Time and Universal Time Co-ordination simulation utilizes progression at the binary-level of the processor to ascertain the Simulation competency. The interaction of the manifestation between the binary language in an electronic logic and execution mode produces the outcome of Universal Time and Universal Time Co-ordination structures. No matter, for this reason, any electronic device uses only binary signals for operation at the bottom-level. The 0's and 1's are the basics for digital electronics. The processed data is stored in the buffer memory (3) according (FIG. 1) for further use due to extensive fragments. The simulation of timescale utilizes recursion (5) Simulation in the instruction-set to carry out repetitive and uninterrupted execution chain while performing the action. The timescale method ensures the recursion procedure (5) in (FIG. 1) which involves a termination point after completing the entire task. The structural formation is the outcome of Universal time simulation that has methods and procedures upon which the outcome is achieved which are disclosed in the claims. The end result is displayed to the user using a display unit like monitor according to (FIG. 1) (20). The structure formation in the invented method handles numerals for the propagation of Universal Time and Universal Time Co-Ordination. The concatenation is utilized to make information more readable and useful according to (FIG. 1) (18). The concatenation helps to shape the processed fragments into well-organized data and informative to the end-user in the user application interface environment using a display unit or a monitor with the final outcome according to (FIG. 1) (20).

### Simulation Method

The timescale involved in the invented method fetches absolute co-ordination by structure formation during the execution in the processor so-called according to (FIG. 1) (7). The geometrical framework in the invented method according to (FIG. 1) (6) provides a reference point for timescale simulation enduring the intersection in the digital environment. An angular progression is defined in a geometrical manifestation with its fractional progression state in the timescale method. This is an inventive feature which provides improved technical effect. The timescale capitalizes angular progression (7) in amalgamation with recursion to generate angular structures. The Angular structure milestone provides a framework for timescale simulation. The invented method standardizes the tropical timescale for initiating specific simulation in connection with Earth. The Tropical Timescale remains beneficial in charting the angular variation in the rotation of Earth by formulating absolute coordination with its timescale module. The Tropical Timescale generated by this invented method provides the framework for the simulation of Universal Time according to (FIG. 1) (14) under Tropical Timescale methodology. The invented method standardizes sidereal timescale with its angular progression, contrasting with static objects for building specific timescale. The sidereal timescale remains as a manifestation in geometrical mapping contrasting with conjunction of other objects. The Sidereal Timescale generated by this method provides the framework for the simulation of Universal Time & Universal Time Co-ordination according to (FIG. 1) (15), using Sidereal timescale methodology which is non-obvious in its functional operation in the action performed by the end-user.

The instruction-set is translated into binary instruction for processing and translated back into the appropriate format for human understanding according to (FIG. 1) (18). For processing the instruction-set, the limitation of the architecture plays a vital role in binary orientation. The described method attempts to define high-level precision in the instruction-set for the set of actions performed. The actions performed do not follow a rigid or a well-defined pattern due to the fact that coordinated simulation method involves an aggregated style of execution practice which is dynamic in nature. Such heavily loaded operations require mass processor capacity or supercomputers for the functionality of nine hundred and ninety-nine million years to generate structures in Universal Time Framework. The functioning of floating-point on the processor architecture is burdensome to compute and maintain top-level integrity and accuracy in the classified timescale. The invented method overrides the processor by providing a leap ahead in technical and technological advancement according to (FIG. 1) numbered as (13).

The invented method facilitates the exploitation of compressed fractional state according to (FIG. 2) (23) to accommodate the enormous length of extreme floating-point along with a whole number or signed integer value as an internal processing action. Hence, binary electronics limitations are crucial for tasks associated with timescale. The invented timescale method provides technical advancement and consistency in the formation and interpretation of instructions according to (FIG. 1) (11). The invented method ensures consistent result out-come with advancement for its utility merits with limited hardware resource usage statistics.

According to (FIG. 2) (21) stays witnessed as a backbone for the timescale in developing their adapted nature for simulation and execution. (FIG. 2) (23). The Dual-angular progression invokes two angular progressions simultaneously for automated mutual intersection by matching similarity in the conjunction state in memory with extensive fragments. The conjunction point provides an adapted timescale for time simulation. In (FIG. 2) (25) the Universal Time simulation is complemented by either Tropical equinox or Sidereal equinox which are methods for handling timescale of a single entity by the invented method. The Universal Time Co-ordination utilizes only the Sidereal Equinox method and attempts to build a mutual conjunction point for its purpose oriented timescale simulation. The presently invented method uses Sidereal Equinox method that devises a singularity in the approach for conscripting Universal Time Co-Ordination by using angular progression.

According to (FIG. 3) (27) The invented method divides the angular progression into sector by sector for mapping framework in the devised methodology and stays witnessed as a mainstay. The invented method acquires the progression and its successive chain to define the framework. The invented method utilizes time simulation from the mid-night after coordination of the default state in the framework for Universal Time and Universal Time Co-ordination.

I claim:

1. A method of simulation for Universal Time and Universal Time Co-Ordination by providing frequent origin milestones based on the relative position of Sun, Moon and Earth for nine-hundred and ninety-nine million years comprising;
(a) Receiving Input data parameters through a native keypad and mouse to support the simulation method through the action performed by the end-user; and
(a) Using the Input-stream reader, receiving data as a signed integer, specifying the range of functional year and using recursion cycle end-point option for termination; and
(b) The user-interface providing functional command options for initiating and performing the simulation method on the processor; and
(c) The user interface provides the data interaction between the end-user and the simulation method; and
(b) Using at least one processor with 32-bit platform architecture and associated memory for the functional association with the minimised hardware configuration of a computer; and
Using output-stream writer for displaying the numeric structural formation of Universal Time and Universal Time Co-ordination in the User Interface window combining with rich-textures for human readability.

2. The method as claimed in claim 1, wherein receiving the input as, signed integer, specifying the range of functional year and using recursion cycle end-point for building a geometrical framework for Universal Time and Universal Time Co-Ordination comprising:
Defining Geometrical framework under Sidereal and Tropical equinox method; and
(a) Initializing the geometrical angle individually to a default state pertaining to a single celestial object timescale for numeric recursion at least one action associated with Universal Time framework; and
Using the angular progression method in combination with numeric recursion by repetitive progression to generate extreme Fractional-State; and
(b) Using the initialized geometrical angle with its default state pertaining to two celestial objects timescale by invoking a dual angular progression for numeric recursion involving two actions associated with Universal Time Co-Ordination framework; and
Using the angular progression method to form mutual conjunction in combination with numeric recursion by repetitive progression to generate extreme Fractional-State; and
The angular progression with its extreme compressed Fractional-State associated with indices indicate plurality, ascertain the processor architecture capacity for generating a geometrical framework for Universal Time & Conjunction point for Universal Time Co-Ordination, else indicating architecture overload to the end-user performing the action.

3. The method as claimed in claim 2, wherein the extreme compressed Fractional-State with geometrical framework pertaining to Universal Time; Comprising
(a) Sidereal Equinox method for determining the geometrical alignment with an individual celestial object by using angular progression method for Universal Time metric; and
Generating Date structures based on the segmentation of the angle that retains timescale and day integrity in Universal Time framework without variation; and
(b) Tropical Equinox method for determining the geometrical alignment concerning with Earth by using angular progression method for Universal Time metric; and
Generating unambiguous geometrical segment in charting variations pertaining to native cyclic proximity in tropical angular progression timescale associated with latitude.

4. The method as claimed in claim 3, wherein determining the Sidereal and Tropical Equinox method using angular progression for an individual celestial object in geometrical mapping with their multiplex nature of floating-point using indices comprising:
Using indices to decompress floating-point to their true nature for accurate Fractional-State in the geometrical framework for angular mapping; and
(a) Applying an accurate Fractional-State pertaining to indices, constructing multiple positioning in geometrical metric using their native angular displacement by using the refreshing angular geometric method; and
Generating an accurate positioning of an individual celestial object in a geometrical framework pertaining to Sidereal and Tropical equinox method.

5. The method as claimed in claim 2, wherein determining conjunction point with Sidereal Equinox method for geometrical alignment for mapping of celestial objects by using concurrent dual angular progression method involving two actions associated with Universal Time Co-ordination comprising;
Utilizing indices to decompress floating-point to their true nature for an accurate Fractional-State in the geometrical intersection and their angular displacement for mutual alignment in the geometrical framework; and
(a) Applying an accurate Fractional-State of geometrical intersection pertaining to indices, constructing an alignment based on their native mutual angular displacement by using the refreshing angular geometric method; and
Generating an accurate positioning of intersection between celestial objects in a geometrical framework pertaining to Sidereal Equinox method and having mutual angular co-ordination.

6. The method as claimed in claim 4 wherein, having accurate positioning of the individual celestial object and multiple positions for generating a timescale in Universal Time; comprising
(a) The accurate angular positioning of individual celestial object formulates sidereal timescale for Universal Time Framework; and
Determining a control using the construction method aligned with sidereal angular progression for Universal Time; and
(b) The accurate angular positioning of Earth formulates tropical timescale in Universal Time framework; and
Determining a control using the construction method aligned with the tropical angular progression of Earth for Universal Time; and
Generating a numeric formation in memory as extreme fragments by significant construction method aligned with a sidereal and tropical timescale for Universal Time.

7. The method as claimed in claim 5 wherein, having the accurate positioning of intersection among celestial objects in the geometrical framework, and having mutual angular Co-ordination comprising:
(a) The optimized angular integrity in combination with three celestial objects for providing classified sidereal timescale simulation in Universal Time Co-Ordination; and
The single classified Sidereal timescale simulation provides frequent origin milestone points to check integrity in the timescale; and
Generating a numeric formation in memory as an extreme fragment by significant method aligned with a sidereal timescale for Universal Time co-ordination.

8. The method as claimed in claim 6 and claim 7, wherein numeric formation in memory as extreme fragments containing specific information pertaining to the native timescale simulation comprising:
Determining the numeric structural formation for Universal Time by the residing data fragment in memory and using its procedural timescale nature for extraction; and
(a) Extraction of numerals using a streamlined sequence and progression to define the structural formation of Universal Time; and
Determining the numeric structural formation of Universal Time relating to a single celestial object with variation in angular metric; and
Determining the numeric structural formation of Universal Time Co-Ordination by residing data fragments in memory and using its procedural sidereal timescale nature for extraction; and
(b) Extraction of numerals using a streamlined sequence and progression ensuring the conjunction time the structural formation of Universal Time co-ordination; and
Determining the formation of Universal Time Co-Ordination relating to two celestial objects in conjunction metric; and
The enormous extraction of numerals with its sequence order to form the accurate date construction an hour, minutes, and seconds in Universal Time and Universal Time Co-ordination.

9. The method as claimed in claim 8, wherein the enormous extraction of numerals with its sequence order, using output-stream formatting constructing meaningful information that is compatible for screen matrix positioning comprising:
Formatting the processed data in memory using the output-stream for String concatenation with rich texture; and
Using an output-device screen layout mapping pertaining to the designed Window size, determining the X axis and Y axis for accurate placement of the extracted numerals in the Window combining with rich textures for readability; and
Generating a screen layout matrix positioning for each available element in memory and related texture information.

10. The method as claimed in claim 1 and claim 9, wherein using the output-stream writer and using the available information for screen matrix positioning comprising:
Using the specific screen-layout matrix information, positioning the numerals in well-aligned pattern with sufficient spacing with-out overlapping; and
Using the new line special character indicating the output-stream end-of-line in the layout window; and
Using the output-stream writer, printing meaningful information with numerals combining with rich textures on the console output window; and
Generating precise information and formation relating to Universal Time and Universal Time co-ordination by the simulation method through the action performed by the end-user.
